(19) United States
(12) Patent Application Publication
(10) Pub. No.: US 2021/0037070 A1
(43) Pub. Date: Feb. 4, 2021

(54) INFORMATION PROCESSING SYSTEM, INFORMATION PROCESSING APPARATUS, INFORMATION PROCESSING METHOD, AND NON-TRANSITORY COMPUTER-READABLE MEDIUM

(71) Applicant: MASAKI ARAI, TOKYO (JP)

(72) Inventor: MASAKI ARAI, TOKYO (JP)

(73) Assignee: Ricoh Company, Ltd., Tokyo (JP)

(21) Appl. No.: 16/940,707

(22) Filed: Jul. 28, 2020

(30) Foreign Application Priority Data
Jul. 31, 2019 (JP) 2019-141790
May 22, 2020 (JP) 2020-089525

(51) Int. Cl. H04L 29/06; G06F 3/14; H04L 29/08

(52) U.S. Cl. CPC H04L 65/4015; H04L 67/1044; G06F 3/1454; H04L 65/403

(57) ABSTRACT

An information processing system includes a plurality of communication terminals, and an information processing apparatus. The information processing apparatus includes first circuitry to acquire one or more images of a shared screen; store the acquired one or more images as one or more captured image; receive a selection of a particular captured image that is not to be displayed on at least one communication terminal of the plurality of communication terminals; generate data of a screen including the one or more captured images to be displayed on the at least one communication terminal, the screen not displaying at least a part of the one or more captured images based on the received selection; and transmit the generated data to the at least one communication terminal. Each of the plurality of communication terminals includes second circuitry configured to display the screen based on the received data.

### CROSS-REFERENCE TO RELATED APPLICATIONS

This patent application is based on and claims priority under 35 U.S.C. § 119(a) to Japanese Patent Application Nos. 2019-141790, filed on Jul. 31, 2019, and 2020-089525, filed on May 22, 2020 in the Japan Patent Office, the entire disclosures of which are incorporated herein by reference.

### BACKGROUND

### Technical Field

The present disclosure relates to an information processing system, an information processing apparatus, an information processing method, and a non-transitory computer-readable medium.

### Description of the Related Art

For example, a meeting support system is known that integrates plural systems each supporting a meeting and respectively having various functions such as a video/audio recording/reproducing function, a whiteboard writing function, and a personal memo function. Such conference support system stores various contents (data) generated by each of the known system in association with each meeting and allows users to refer to and utilize the stored contents in association.

For example, in an information processing system that provides a user with a function of acquiring an image of a shared screen displayed on a plurality of communication terminals and allows the user to refer to the acquired image, for example, even when one or more of the users later recognize that the image on the shared screen is not suitable for sharing, such as the image including confidential information, there is difficulty in prevent the user from referring to the shared screen image acquired by the user later.

### SUMMARY

According to one or more embodiments, an information processing system includes a plurality of communication terminals, and an information processing apparatus. The information processing apparatus includes first circuitry to acquire one or more images of a shared screen to be shared by the plurality of communication terminals, each image being captured in response to occurrence of a trigger for capturing an image of the shared screen; store the acquired one or more images as one or more captured image, in a memory; receive a selection of a particular captured image that is not to be displayed on at least one communication terminal of the plurality of communication terminals from the one or more captured images; generate data of a screen including the one or more captured images to be displayed on the at least one communication terminal, the screen not displaying at least a part of the one or more captured images based on the received selection; and transmit the generated data to the at least one communication terminal. Each of the plurality of communication terminals includes second circuitry configured to display the screen based on the data received from the information processing apparatus.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating an overview of an information sharing system used in a meeting being conducted, according to an embodiment of the present disclosure;

FIG. 2 is a diagram illustrating an example of an overview of a personal portal in the information sharing system, according to an embodiment of the present disclosure;

FIG. 3 is a block diagram illustrating an example of a hardware configuration of a computer, according to an embodiment of the present disclosure;

FIG. 4 is a block diagram illustrating an example of a hardware configuration of a smartphone, according to an embodiment of the present disclosure;

FIG. 5 is a block diagram illustrating an example of a functional configuration of a personal terminal and a content management server of the information sharing system, according to an embodiment of the present disclosure;

FIG. 6 is a table illustrating an example of a data structure of a personal memo database (DB), according to an embodiment of the present disclosure;

FIG. 7 is a table illustrating an example of a data structure of a user management DB, according to an embodiment of the present disclosure;

FIG. 8A, FIG. 8B and FIG. 8C are illustrations of an example of data structure of a content management DB, according to an embodiment of the present disclosure;

FIG. 9 is an illustration for describing an example of an image of a shared screen ss and a capture image obtained by capturing the shared screen ss, according to an embodiment of the present disclosure;

FIG. 10 is an illustration for describing an example of invalidation of a capture image obtained by capturing the shared screen ss and memo information associated with the capture image, according to an embodiment of the present disclosure;

FIG. 11 is a flowchart illustrating an example of an operation performed by the information sharing system, according to an embodiment of the present disclosure;

FIG. 12 is a flowchart illustrating an example of an invalidation operation, according to an embodiment of the present disclosure;

FIG. 13 is an illustration of an example of a capture image display screen, according to an embodiment of the present disclosure;

FIG. 14 is an illustration of an example of the capture image display screen on which a capture operation screen is displayed, according to an embodiment of the present disclosure;

FIG. 15 is an illustration for describing an example of an image of the shared screen ss and a capture image obtained by capturing the shared screen ss, according to an embodiment of the present disclosure;

FIG. 16 is a flowchart illustrating an example of an invalidation operation, according to an embodiment of the present disclosure;

FIG. 17 is an illustration of an example of the capture image display screen on which the capture operation screen is displayed, according to an embodiment of the present disclosure; and

FIG. 18 is a schematic diagram illustrating an overview of the information sharing system used in a meeting being conducted, according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Embodiments of the present disclosure are described in detail below, with reference to the drawings. Although a description given hereinafter is of an example of an information sharing system used in a meeting, seminar, lecture, class or the like. However, this is just an example, and the embodiments are applied to various kinds of information processing system. In the embodiments, in one example, all users are in the same room such as a conference room. In another example, users who are connected through a network are in physically separated rooms. A description is given hereinafter of an example in which a meeting is conducted with the information sharing system, which is an example of an information processing system according to the present embodiment.

### First Embodiment

Overview of Information Sharing System Used in Meeting:

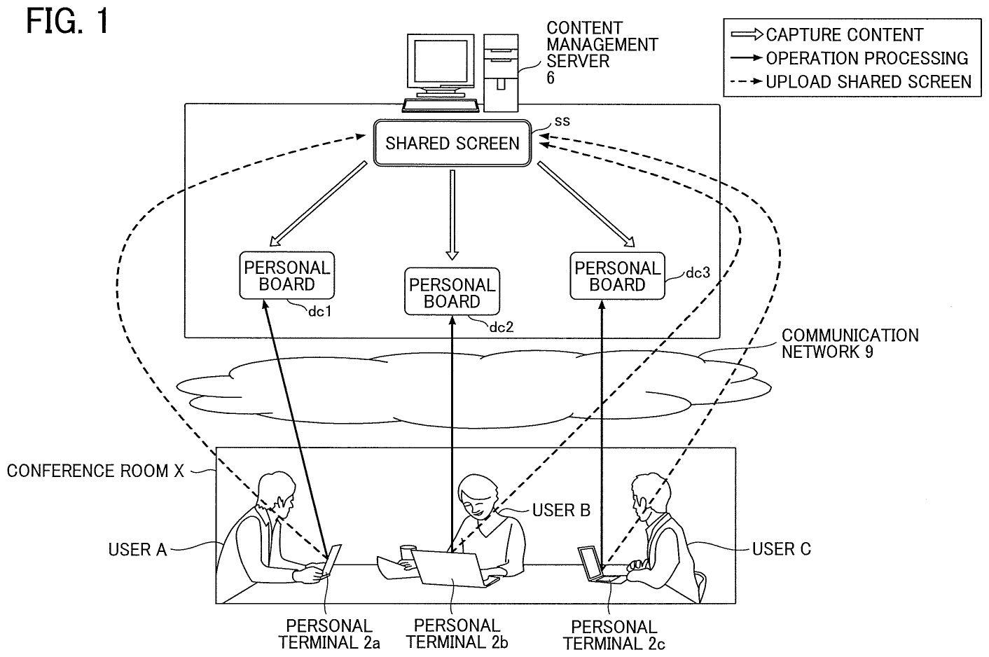

First, with reference to FIG. 1, an overview of an information sharing system according to the present embodiment is described. In the embodiment, a meeting is being held using the information sharing system. FIG. 1 is a schematic diagram illustrating an overview of the information sharing system used in a meeting being conducted, according to the present embodiment. FIG. 1 illustrates an example case in which a user A, a user B, and a user C who are in a conference room X of a company are conducting a remote meeting by using the information sharing system. In the conference room X, the user A uses a personal terminal 2a, the user B uses a personal terminal 2b, and the user C uses a personal terminal 2c. In the following description, the personal terminal 2a, the personal terminal 2b, and the personal terminal 2c are collectively referred to as simply a “personal terminal 2” or “personal terminals 2”, unless these terminals need to be distinguished from each other. Further, in the following, an example is described in which the user A is a presenter, and the users B and the user C are attendees. The meeting may be also referred to as the conference, gathering, or the like.

The personal terminal 2 is a computer that a user can use individually or exclusively and whose screen is viewed (browsed) by the user individually. The personal terminal 2 is not limited to being privately-owned. The personal terminal 2 may be public, private, non-profit, rental or any other type of ownership terminal in which a user may individually or exclusively use the terminal and whose screen is viewed by the user individually. Examples of the personal terminal 2 include, but not limited to, a laptop computer, a desktop personal computer (PC), a mobile phone, a smartphone, a tablet terminal, and a wearable PC. The personal terminal 2 is an example of a communication terminal (or an information processing terminal).

The personal terminal 2 is communicable with a content management server 6 through a communication network 9 such as the Internet. The communication network 9 is, for example, one or more local area networks (LANs) inside the firewall. In another example, the communication network 9 includes the Internet that is outside the firewall in addition to the LAN. In still another example, the communication network 9 further includes a virtual private network (VPN) and/or a wide-area Ethernet (registered trademark). The communication network 9 is any one of a wired network, a wireless network, and a combination of the wired network and the wireless network. In a case where the content management server 6 and the personal terminal 2 connects to the communication network 9 through a mobile phone network such as 3G, Long Term Evolution (LTE), 4G, the LAN can be omitted.

The content management server 6 is a computer functioning as a web server (or HTTP server) that stores and manages data of contents to be transmitted to the personal terminal 2. The content management server 6 includes a storage unit 6000 described below.

The storage unit 6000 includes storage locations (or storage areas) for implementing personal boards dc1 to personal board dc3, which are accessible only from each personal terminal 2. Specifically, only the personal terminal 2a, the personal terminal 2b and the personal terminal 2c can access a personal board dc1, a personal board dc2 and a personal board dc3, respectively. In the following description, the personal board dc1, the personal board dc2, and the personal board dc3 are collectively referred to as simply a “personal board de”, unless these boards need to be distinguished from each other. In one example, the content management server 6 supports cloud computing. The “cloud computing” refers to internet-based computing where resources on a network are used or accessed without identifying specific hardware resources. The storage unit 6000 of the content management server 6 includes a storage location (or storage area) for implementing a shared screen ss described below.

The “personal board dc” is a virtual space generated in the storage location (or the storage area) in the storage unit 6000 of the content management server 6. For example, the personal board dc is accessible by using a web application having a function of allowing a user to view and edit contents with the Canvas element and JavaScript (registered trademark).

The “web application” refers to software used on a web browser application (hereinafter referred to as a “web browser”, in order to simplify the description). The web application is implemented by a program written in a script language such as JavaScript (registered trademark) that operates on the web browser and a program on a web server side, which operate in cooperation with each other. Further, the web application refers to a mechanism that implements such software. The personal board dc has a finite or an infinite area within the range of the storage area in the storage unit 6000. For example, the personal board dc may be finite or infinite both in the vertical and horizontal directions. In another example, the personal board dc may be finite or infinite in either the vertical direction or the horizontal direction.

The “shared screen ss” is a virtual space generated in the storage location (or the storage area) in the storage unit 6000 of the content management server 6. The shared screen ss has a function of holding content data that is uploaded by streaming from the personal terminal 2a of the user A, who is the presenter, until next content data is acquired. The shared screen ss is a computer screen such as an application screen. The shared screen ss is a capturing target of a capture image, as described below.

The personal board dc is an electronic space dedicated to each of users participating in the meeting. The personal terminal 2 of each user can access only the personal board dc dedicated to the corresponding user, which allows the corresponding user to view and/or edit (input, delete, copy, etc.) contents such as characters and images on the accessed personal electronic canvas.

The content management server 6 stores, for each virtual conference room, information (data) such as contents developed on the shared screen ss and the personal board dc in association with the corresponding virtual conference room. The virtual conference room is an example of a virtual room. Hereinafter, the virtual conference room is referred to as a “room”, in order to simplify the description. Thereby, even when the content management server 6 manages plural rooms, data of a content are not communicated over different rooms.

Each personal terminal 2 causes the web application operating on the web browser installed in the personal terminal 2 to access the contents of the personal board dc and the shared screen ss of the room in which the user participates. Thus, the meeting is held in a manner that is close to a meeting conducted in the real conference room.

The information sharing system, the user A, who is a presenter, causes a capture image of a content uploaded to the shared screen ss to be taken into the personal board dc of the users B and the user C, who are attendees, as a personal document, as described below. Further, the information sharing system allows the user A, who is the presenter, to invalidate the capture image captured to the personal boards dc of the users B and the user C during the meeting, and additional information (memo information) such as text, graphic objects and vector data associated with the capture image so that the capture image and the additional information are not displayed, as described below.

Overview of Personal Portal in Information Sharing System:

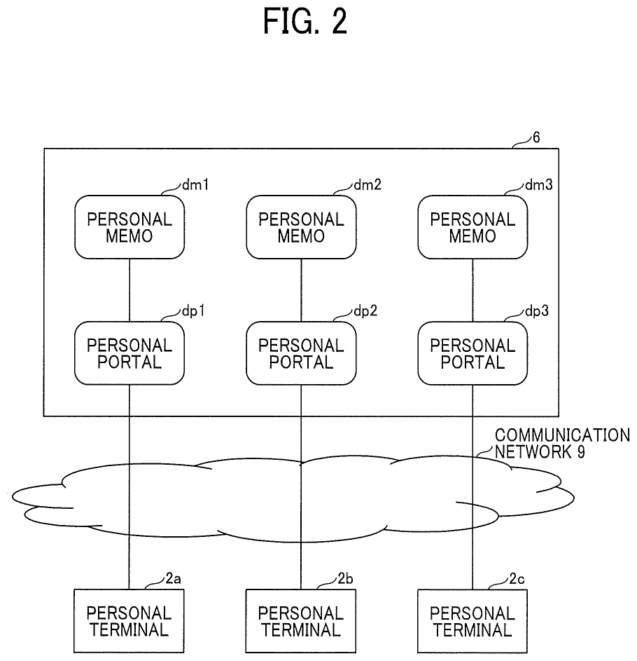

A description is now given of an overview of a personal portal, with reference to FIG. 2. FIG. 2 is a diagram illustrating an example of an overview of a personal portal in the information sharing system. The content management server 6 generates data for a personal portal screen dp1, a personal portal screen dp2, and a personal portal screen dp3 dedicated to the personal terminal 2a, the personal terminal 2b, and the personal terminal 2c, respectively, to cause the personal terminals 2 to perform display based on the generated data. In the following description, the personal portal screen dp1, the personal portal screen dp2, and the personal portal screen dp3 are collectively referred to a simply a “personal portal screen dp”, unless these portal screens need to be distinguished from each other.

The content management server 6 stores and manages a personal memo dm1, a personal memo dm2, and a personal memo dm3, which are contents edited on the personal board dc1, the personal board dc2, and the personal board dc3, respectively. In the following description, the personal memo dm1, the personal memo dm2, and the personal memo dm3 are collectively referred to as simply a “personal memo dm”, unless these personal memos need to be distinguished from each other. Each user accesses the personal portal screen dp dedicated to each personal terminal 2, to cause a list of meetings in which the user who operates the corresponding personal terminal 2 has participated to be displayed.

The user can cause the personal memo dm (excluding an invalidated capture image and memo information associated with the invalidated capture image) of each meeting and reference information of the meeting to be displayed from a list of meetings displayed on the personal portal screen dp, as described below. Thus, for example, when a user wants to look back contents of meetings, the user can cause the personal memo dm of a desired meeting and the reference information of the desired meeting to be displayed within a range that is not invalidated in a simple manner. Further, each user accesses the personal portal screen dp dedicated to each personal terminal 2, to search a list of the meetings of the user operating the corresponding personal terminal 2 for a desired meeting by using a keyword (text). For example, the reference information of the meeting, text and handwritten characters included in the personal memo dm, and the evaluation of the meeting by the user are searched through by using characters (text). Note that the reference information of the meeting is included in the meeting information.

Hardware Configuration:

Hardware Configuration of Computer:

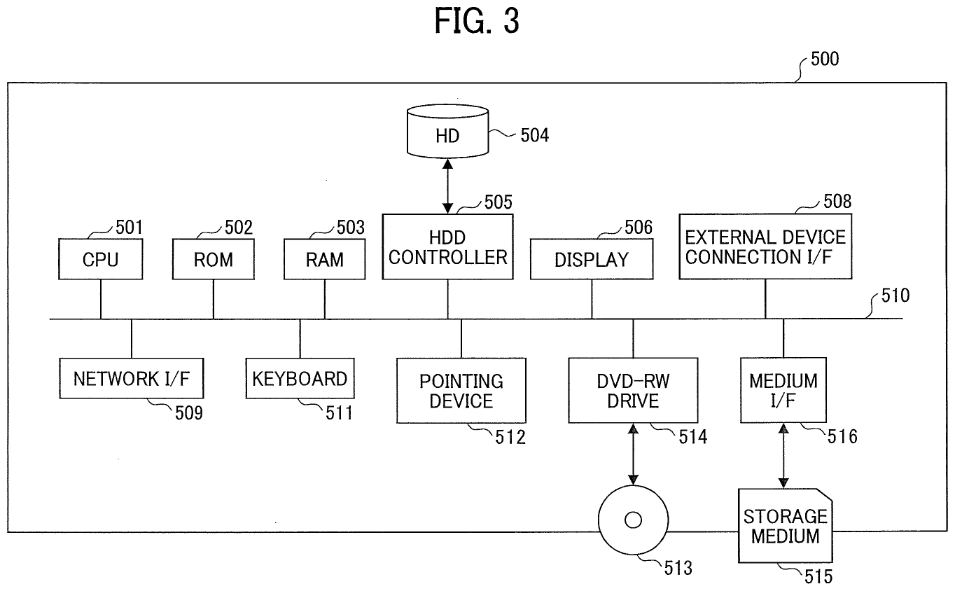

The content management server 6 is implemented by, for example, a computer 500 having a hardware configuration as illustrated in FIG. 3. Further, when the personal terminal 2 is a PC, which is an example of an information processing terminal, the PC is also implemented by the computer 500 having a hardware configuration as illustrated in FIG. 3, for example.

FIG. 3 is a block diagram illustrating an example of a hardware configuration of the computer 500, according to the present embodiment. As illustrated in FIG. 3, the computer 500 includes, for example, a central processing unit (CPU) 501, a read only memory (ROM) 502, a random access memory (RAM) 503, a hard disk (HD) 504, a hard disk drive (HDD) controller 505, and a display 506, an external device connection interface (I/F) 508, a network I/F 509, a data bus 510, a keyboard 511, a pointing device 512, a digital versatile disk rewritable (DVD-RW) drive 514, and a medium I/F 516.

The CPU 501 controls entire operation of the computer 500. The ROM 502 stores programs for controlling the CPU 501, such as an initial program loader (IPL). The RAM 503 is used as a work area for the CPU 501. The HD 504 stores various data such as a program. The HDD controller 505 controls reading and writing of various data from and to the HD 504 under control of the CPU 501.

The display 506 displays various information such as a cursor, menu, window, character, and image. The external device connection I/F 508 is an interface that connects the computer 500 to various external devices. Examples of the external devices include, but not limited to, a universal serial bus (USB) memory and a printer. The network I/F 509 is an interface that controls communication of data with an external device through the communication network 9. Examples of the data bus 510 include, but not limited to, an address bus and a data bus, which electrically connects the components such as the CPU 501 with one another.

The keyboard 511 is one example of an input device provided with a plurality of keys for allowing a user to input characters, numerals, or various instructions. The pointing device 512 is an example of an input device that allows a user to select or execute a specific instruction, select a target for processing, or move a cursor being displayed. The DVD-RW drive 514 reads and writes various data from and to a DVD-RW 513, which is an example of a removable storage medium. The removable storage medium is not limited to the DVD-RW and may be a digital versatile disc-recordable (DVD-R) or the like. The medium I/F 516 controls reading and writing (storing) of data from and to a storage medium 515 such as a flash memory.

Hardware Configuration of Smartphone:

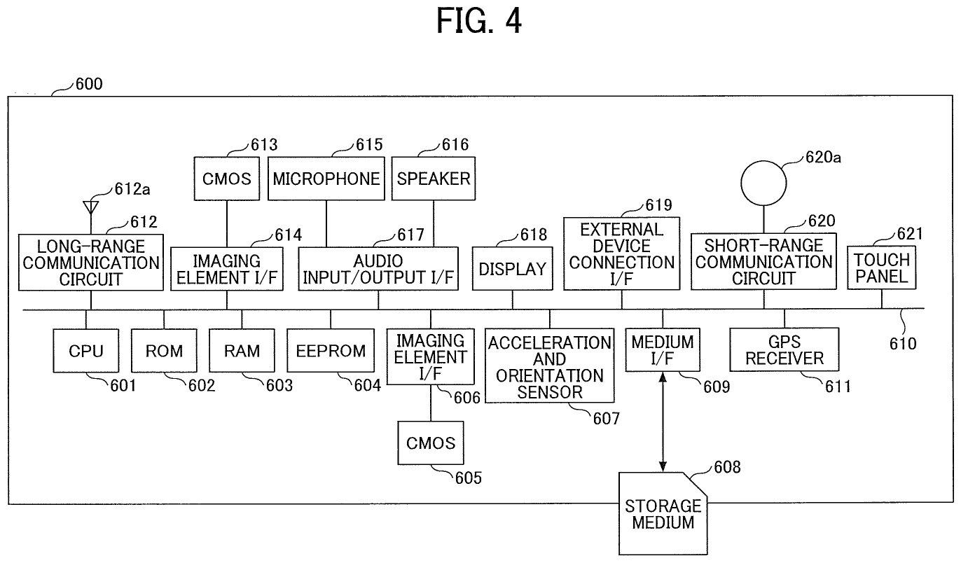

The personal terminal 2, which is an example of the information processing terminal, can be implemented by, for example, a smartphone 600 having a hardware configuration as illustrated in FIG. 4.

FIG. 4 is a block diagram illustrating an example of a hardware configuration of the smartphone 600, according to the present embodiment. As illustrated in FIG. 4, the smartphone 600 includes, for example, a CPU 601, a ROM 602, a RAM 603, an electrically erasable and programmable ROM (EEPROM) 604, a complementary metal oxide semiconductor (CMOS) sensor 605, an imaging element I/F 606, an acceleration and orientation sensor 607, a medium I/F 609, and a global positioning system (GPS) receiver 611.

The CPU 601 controls entire operation of the smartphone 600. The ROM 602 stores a control program for controlling the CPU 601, such as an IPL. The RAM 603 is used as a work area for the CPU 601. The EEPROM 604 reads or writes various data such as a control program for a smartphone under control of the CPU 601.

The CMOS sensor 605 is an example of a built-in imaging device configured to capture an object (mainly, a self-image of a user operating the smartphone 600) under control of the CPU 601 to obtain image data. In alternative to the CMOS sensor 605, an imaging element such as a charge-coupled device (CCD) sensor can be used. The imaging element I/F 606 is a circuit that controls driving of the CMOS sensor 605. Example of the acceleration and orientation sensor 607 includes an electromagnetic compass or gyrocompass for detecting geomagnetism and an acceleration sensor.

The medium I/F 609 controls reading and writing (storing) of data from and to a storage medium 608 such as a flash memory. The GPS receiver 611 receives a GPS signal from a GPS satellite.

The smartphone 600 further includes a long-range communication circuit 612, a CMOS sensor 613, an imaging element I/F 614, a microphone 615, a speaker 616, an audio input/output I/F 617, a display 618, an external device connection I/F 619, a short-range communication circuit 620, an antenna 620a for the short-range communication circuit 620, and a touch panel 621.

The long-range communication circuit 612 is a circuit that enables the smartphone 600 to communicate with other device through the communication network 9. The CMOS sensor 613 is an example of a built-in imaging device configured to capture an object under control of the CPU 601 to obtain image data. The imaging element I/F 614 is a circuit that controls driving of the CMOS sensor 613. The microphone 615 is a built-in circuit that converts sound into an electric signal. The speaker 616 is a built-in circuit that generates sound such as music or voice by converting an electric signal into physical vibration.

The audio input/output I/F 617 is a circuit for inputting or outputting an audio signal between the microphone 615 and the speaker 616 under control of the CPU 601. The display 618 is an example of a display device that displays an image of the object, various icons, etc. Examples of the display 618 include a liquid crystal display (LCD) and an organic electroluminescence (EL) display.

The external device connection I/F 619 is an interface that connects the smartphone 600 to various external devices. The short-range communication circuit 620 is a communication circuit that communicates in compliance with the near field communication (NFC), the Bluetooth (Registered Trademark), and the like. The touch panel 621 is an example of an input device configured to enable a user to operate the smartphone 600 by touching a screen of the display 618.

The smartphone 600 further includes a bus line 610. Examples of the bus line 610 include, but not limited to, an address bus and a data bus, which electrically connects the components illustrated in FIG. 4 such as the CPU 601.

<Functional Configuration>

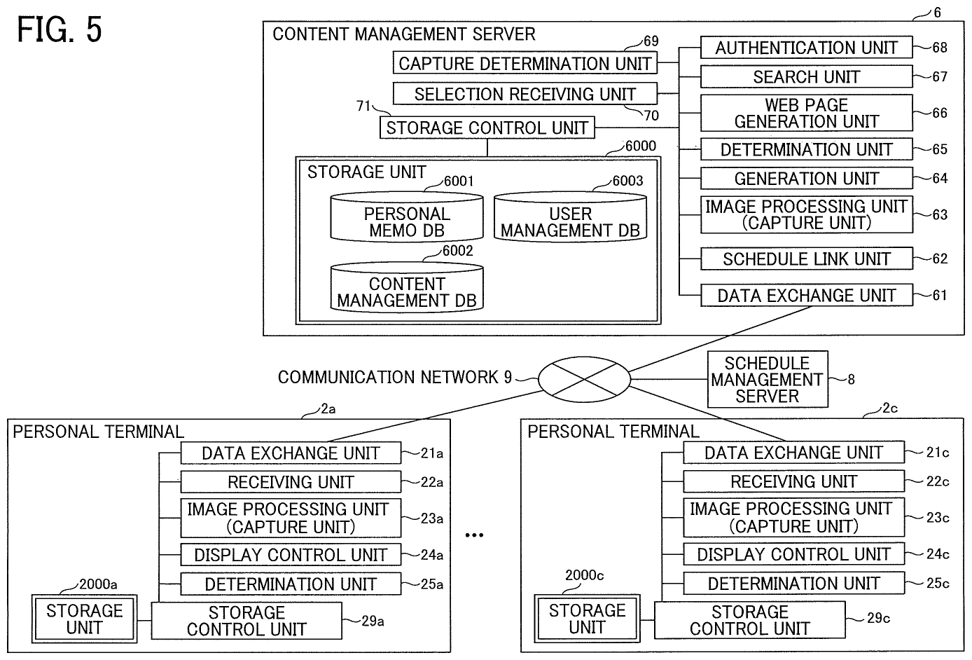

With reference to FIG. 5, a description is given of an example of a functional configuration of each of the personal terminal 2 and the content management server 6 of the information sharing system. FIG. 5 is a block diagram illustrating an example of functional configurations of the personal terminal 2 and the content management server 6 of the information sharing system.

Functional Configuration of Personal Terminal:

First, a description is given of an example of a functional configuration of the personal terminal 2. As illustrated in FIG. 5, the personal terminal 2 includes, for example, a data exchange unit 21, a receiving unit 22, an image processing unit 23, a display control unit 24, a determination unit 25, and a storage control unit 29. These units are functions or means implemented by or caused to function by operating one or more hardware components illustrated in FIG. 3, for example, in cooperation with instructions of the CPU 501 according to the program loaded from the HD 504 to the RAM 503. The personal terminal 2 further includes a storage unit 2000, which is implemented by the RAM 503 and the HD 504 illustrated in FIG. 3.

The data exchange unit 21, the receiving unit 22, the image processing unit 23, the display control unit 24, the determination unit 25, and the storage control unit 29 are implemented by the web browser (the web application of the web browser) that displays a personal board screen.

Each Functional Unit of Personal Terminal: Next, a detailed description is given of each functional unit of the personal terminal 2. The data exchange unit 21 transmits and receives various data (or information) to and from other terminals, apparatuses, servers, etc. through the communication network 9. For example, the data exchange unit 21 receives, from the content management server 6, content data described in a hypertext markup language (HTML), Cascading Style Sheet (CSS), and JavaScript (registered trademark). In addition, the data exchange unit 21 transmits operation information input by the user to the content management server 6.

The receiving unit 22 receives various selections or instructions input by the user using the keyboard 511 and the pointing device 512. The image processing unit 23 performs processing such as generating vector data (or stroke data) according to drawing by the user, for example. The image processing unit 23 has a function as a capturing unit. For example, the image processing unit 23 shoots a capture of the shared screen ss, to acquire a capture image.

The display control unit 24 controls the display 506 to display a personal board screen described below. The determination unit 25 performs various determinations. The storage control unit 29 is implemented by instructions from the CPU 501, and the HDD controller 505, the medium I/F 516, and the DVD-RW drive 514. The storage control unit 29 stores various data in the storage unit 2000, the DVD-RW 513, and the storage medium 515, and reads the various data from the storage unit 2000, the DVD-RW 513, and the storage medium 515.

Functional Configuration of Content Management Server:

A description is now given of an example of a functional configuration of the content management server 6. As illustrated in FIG. 5, the content management server 6 includes, for example, a data exchange unit 61, a schedule link unit 62, an image processing unit 63, a generation unit 64, a determination unit 65, a web page generation unit 66, a search unit 67, an authentication unit 68, a capture determination unit 69, a selection receiving unit 70, and a storage control unit 71. These units are functions or means implemented by or caused to function by operating one or more hardware components illustrated in FIG. 3, for example, in cooperation with instructions of the CPU 501 according to the program loaded from the HD 504 to the RAM 503. The content management server 6 further includes a storage unit 6000, which is implemented by the RAM 503 and the HD 504 illustrated in FIG. 3.

Each Functional Unit of Content Management Server:

Next, a detailed description is given of each functional unit of the content management server 6. The data exchange unit 61 transmits and receives various data (or information) to and from other terminals, apparatuses, servers, etc. through the communication network 9. The schedule link unit 62 acquires schedule information including reference information of the meeting in which the user participates from a schedule management server 8. The schedule management server 8 is connected to the communication network 9 so that various data (or information) can be transmitted and received. The schedule management server 8 stores schedule information (meeting (list) information) for each user (each user ID).

The image processing unit 63 has a function as a capturing unit, and performs screen capturing of the shared screen ss described below, to acquire a capture image. The generation unit 64 generates data to be stored in the personal memo database (DB) 6001, a user management DB 6002, and a content management DB 6003. The determination unit 65 performs various determinations.

The web page generation unit 66 generates data of a web page to be displayed on the web browser of the personal terminal 2 as described below. The search unit 67 accepts a search request from the personal portal screen displayed on the web browser of the personal terminal 2 and performs a search according to the accepted search request. The authentication unit 68 performs user authentication processing. The authentication unit 68 can be provided in any suitable sources other than the content management server 6. For example, an authentication server connected to the communication network 9 can be used.

The capture determination unit 69 detects an occurrence of a trigger for acquiring a capture image, such as receiving a capture shooting request from the personal terminal 2. The selection receiving unit 70 receives, from the user A, who is the presenter, a selection of a capture image to be invalidated from the acquired capture images.

The storage control unit 71 is implemented by instructions from the CPU 501, and the HDD controller 505, the medium I/F 516, and the DVD-RW drive 514. The storage control unit 71 stores various data in the storage unit 6000, the DVD-RW 513, and the storage medium 515, and reads the various data from the storage unit 6000, the DVD-RW 513, and the storage medium 515.

The storage unit 6000 of the content management server 6 stores the personal memo DB 6001, the user management DB 6002, and the content management DB 6003. Note that these data may be stored in any suitable server other than the content management server 6. In this case, the data may be acquired and transmitted from other server each time the personal terminal 2 sends a request for data acquisition and transmission. In another example, the data is stored in the content management server 6 during the meeting or while the personal board dc is referenced by the user, and the data can be deleted from the content management server 6 and sent to other server after the end of the meeting or the reference (or after a certain period of time).

The apparatuses or devices described in the embodiment are merely one example of plural computing environments that implement one or more embodiments disclosed herein. In some embodiments, the content management server 6 includes multiple computing devices, such as a server cluster. The multiple computing devices are configured to communicate with one another through any type of communication link, including a network, a shared memory, etc., and perform processes disclosed herein. In substantially the same manner, the personal terminal 2 can include multiple computing devices configured to communicate with one another.

Further, the content management server 6 and the personal terminal 2 can be configured to share the disclosed processes in various combinations. For example, a part of processes to be executed by the content management server 6 can be executed by the personal terminal 2. Further, the elements of the content management server 6 and the personal terminal 2 may be combined into one apparatus or may be divided into a plurality of apparatuses.

DB Structure:

Personal Memo DB:

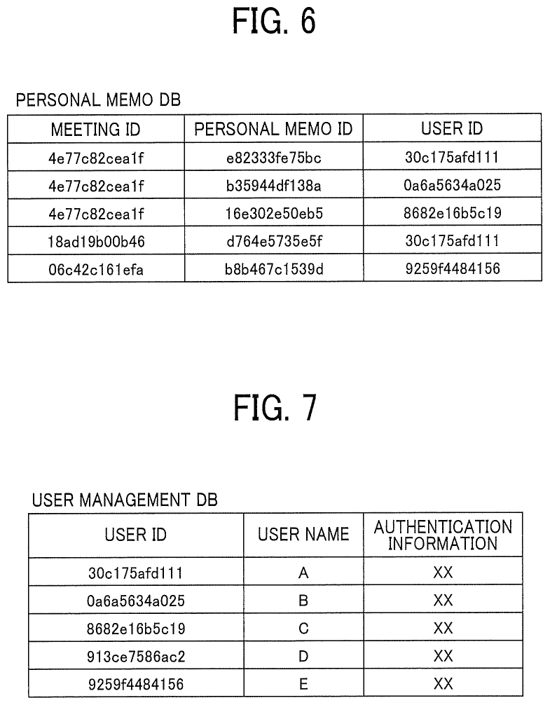

FIG. 6 is a table illustrating an example of a data structure of the personal memo DB 6001. The storage unit 6000 of the content management server 6 stores the personal memo DB 6001 as illustrated in FIG. 6. The personal memo DB 6001 of FIG. 6 stores a meeting ID, a personal memo ID, and a user ID in association with one other. The meeting ID is an example of identification information for identifying a meeting. The personal memo ID is an example of identification information for identifying a personal memo dm. The user ID is an example of user identification information for identifying a user.

In the personal memo DB 6001 of FIG. 6, one or more personal memo IDs for each user is generated with the meeting ID as a base.

User Management DB:

FIG. 7 is a table illustrating an example of a data structure of the user management DB 6002. The storage unit 6000 of the content management server 6 stores the user management DB 6002 as illustrated in FIG. 7. The user management DB 6002 of FIG. 7 stores a user ID, a user name, and authentication information in association with each another. The user ID is an example of user identification information for identifying a user. The user name is a name of the user. The authentication information is used for user authentication processing.

The user management DB 6002 of FIG. 7 stores the user name and the authentication information in association with the user ID.

Content Management DB:

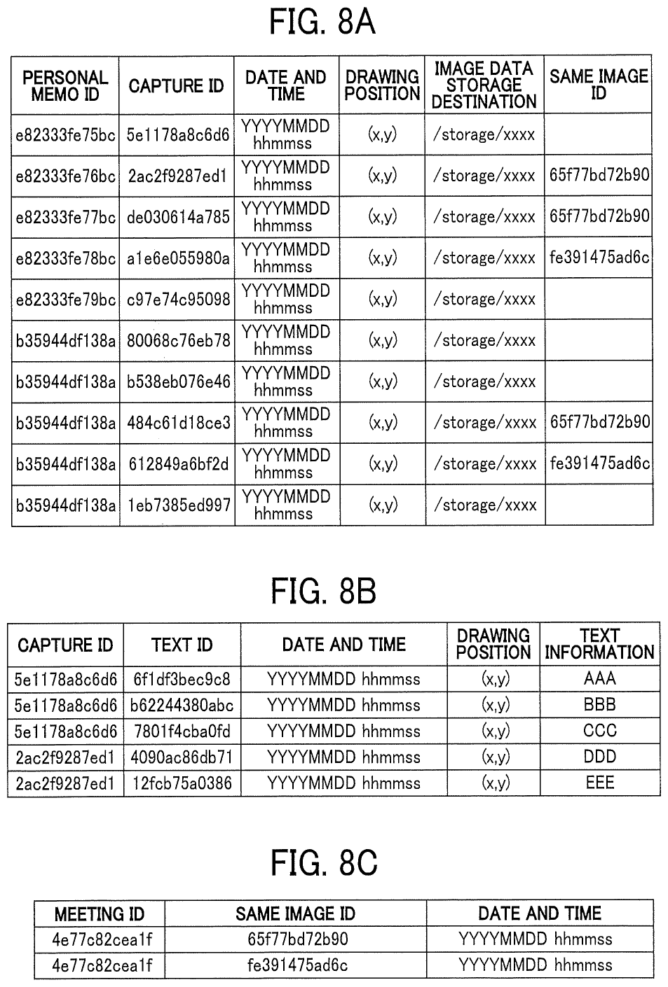

FIGS. 8A, 8B and 8C are tables illustrating an example of a data structure of the content management DB 6003. The storage unit 6000 of the content management server 6 stores the content management DB 6003 as illustrated in FIG. 8, for example.

The table of FIG. 8A stores the personal memo ID, a capture ID, a date and time, a drawing position, an image data storage destination, and a same image ID in association with each other. The table of FIG. 8A is associated with the personal memo DB 6001 of FIG. 6 by the personal memo ID. The capture ID is an example of identification information for identifying a capture image. The date and time indicates a date and time when the capture image was captured. The drawing position indicates a position where the capture image is drawn. The image data storage destination indicates a data storage destination of image data such as graphic objects and vector data. The same image ID is an example of identification information for identifying a capture image of the same image. The capture images having the same image ID are the capture images of the shared screen ss on which the same content is displayed. The table of FIG. 8A stores the personal memo dm and the capture image in association with each other.

A table of FIG. 8B stores the capture ID, a text ID, a date and time, a drawing position, and text information in association with each other. The table of FIG. 8B is associated with the table of FIG. 8B by the capture ID. The text ID is an example of identification information for identifying text written in the capture image. In other words, the text ID is an example of identification information for identifying text associated with the capture image. The date and time is a date and time when the text was written. The drawing position indicates a position where the text is written. The text information indicates a content of the written text. The table of FIG. 8B stores the capture image and the text written in the capture image in association with each other.

A table of FIG. 8C stores the meeting ID, the same image ID, and the date and time in association with each other. In the table of FIG. 8C, among capture images captured in the same meeting, capture images of the shared screen ss displaying the same content are identified by the same image ID.

Processes or Operation:

A description is now given of an operation or processes, according to the present embodiment. In the present embodiment, an example is described in which in a meeting conducted by the room, the user A, who operates the personal terminal 2a, uploads (streams) content data to the shared screen ss, and the user B and the user C, who respectively operate the personal terminal 2b and the personal terminal 2c participate in the meeting and capture a capture image. The user A is an example of a presenter. Each of the user B and the user C is an example of an attendee.

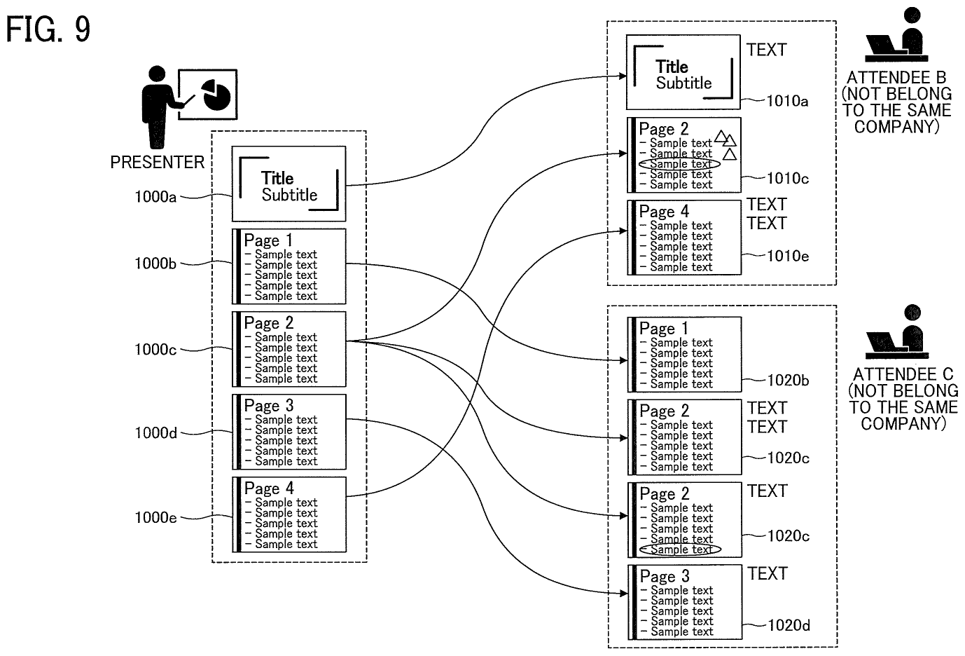

FIG. 9 is an illustration for describing an example of an image of the shared screen ss and a capture image obtained by capturing the shared screen ss. FIG. 9 illustrates an example in which the user A, who is the presenter, uploads five types of images 1000a to 1000e of shared screen ss. For example, the images 1000a to 1000e on the shared screen ss in FIG. 9 are images of each page of the presenter's presentation material.

Further, in the example of FIG. 9, the attendee B captures a capture image 1010a of the image 1000a of the shared screen ss, a capture image 1010c of the image 1000c of the shared screen ss, and a capture image 1010e of the image 1000e of the shared screen ss during the meeting. Furthermore, FIG. 9 illustrates an example in which the attendee B enters text in the capture images 1010a and 1010e. Still further, FIG. 9 illustrates an example in which the attendee B draws graphic objects, vector data and the like in the capture image 1010c.

Further, in the example of FIG. 9, the attendee C captures a capture image 1020b of the shared screen ss image 1000b, two capture images 1020c of the image 1000c of the shared screen ss, and a capture image 1020d of the image 1000d of the shared screen ss during the meeting. Furthermore, FIG. 9 illustrates an example in which the attendee C enters text in the capture images 1020c and 1020d. Still further, FIG. 9 illustrates an example in which the attendee C draws, a graphic object, vector data and the like in the capture image 1020c.

For example, in the example of FIG. 9, it is assumed that the presenter later notices that the presenter should not have allowed the attendee B and the attendee C to capture the image 1000c of the shared screen ss, because the image 1000c of the shared screen ss is not suitable for sharing, such as the image 1000c of the shared screen ss containing confidential information.

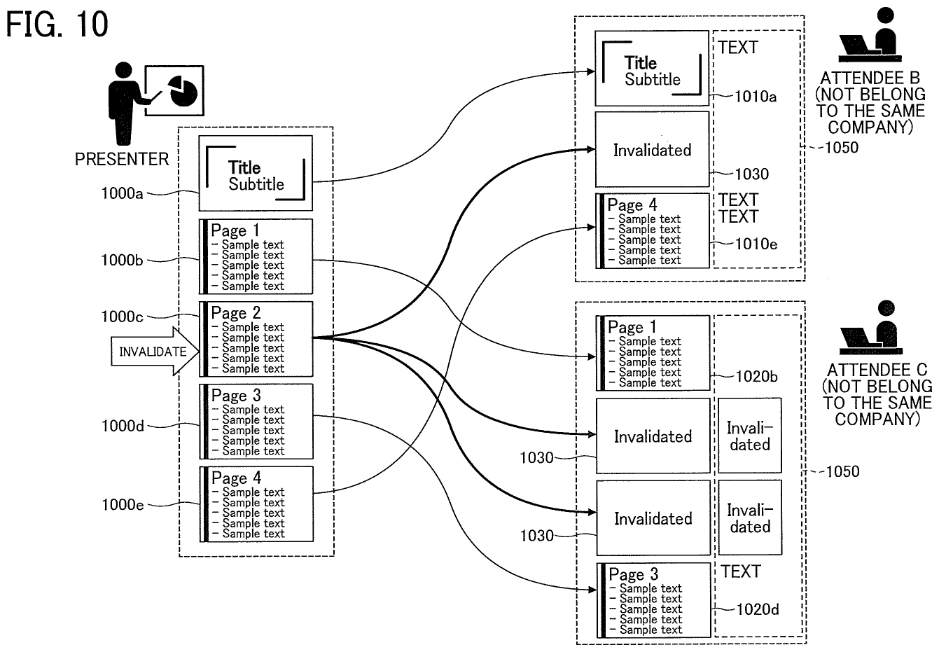

In such a case, the information sharing system according to the present embodiment provides a mechanism for invalidating the capture image 1010c of the image 1000c of the shared screen ss captured by the attendee B and the capture image 1020c of the image 1000c of the shared screen ss captured by the attendee C, so that the capture image 1010c and the capture image 1020c are not displayed, as illustrated in FIG. 10. Invalidation includes deleting, editing, or updating a part of data in the content management DB 6003 so that at least a part of the capture image captured in response to a request from the personal terminal 2 of the attendee is not displayed in the personal memo displayed by the attendee. In FIG. 10, what is displayed on the personal terminal 2 of each of the attendees is the personal memo of each attendee. A detailed description is given below of the invalidation.

FIG. 10 is an illustration for describing an example of invalidation of a capture image obtained by capturing the shared screen ss and memo information associated with the capture image. As illustrated in FIG. 10, when the presenter later notices that the presenter should not have allowed the attendee B and the attendee C to capture the image 1000c of the shared screen ss, the presenter selects the image 1000c of the shared screen ss, to invalidate the capture image 1010c and the capture image 1020c obtained by capturing the image 1000c of the shared screen ss. Further, as illustrated in FIG. 10, memo information such as text, graphic objects, and vector data associated with the invalidated capture image 1010c and the invalidated capture image 1020c is also invalidated.

As illustrated in FIG. 10, the effect of the selection by the presenter of the image 1000c of the shared screen ss and the invalidation of the capture image 1010c and the capture image 1020c obtained by capturing the image 1000c of the shared screen ss is applied to each of the attendees of the meeting. Further, as illustrated in FIG. 10, when the capture image 1020c includes a plurality of capture image of the same page, each capture image 1020c is invalidated.

The embodiment is not limited to the example illustrated in FIG. 10, and for example, the memo information such as text, graphic objects, and vector data associated with the invalidated capture image 1010c and the invalidated capture image 1020c may be left without being invalidated.

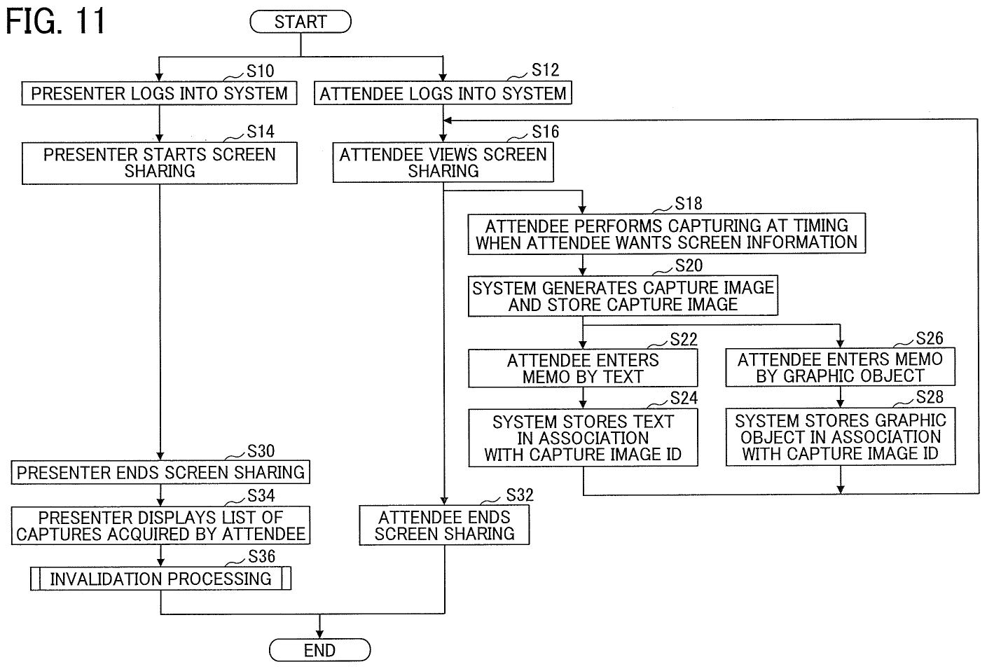

FIG. 11 is a flowchart illustrating an example of an operation performed by the information sharing system, according to the present embodiment. In step S10, the information sharing system receives a login from the presenter, who operates the personal terminal 2a, and performs meeting preparation. The user management DB 6002 illustrated in FIG. 7 is used in the login process in step S10. For example, in the meeting preparation, a room is prepared in response to a request from the personal terminal 2a by the presenter.

In step S12, the information sharing system receives logins from the attendee B and the attendee C, who respectively operate the personal terminal 2b and the personal terminal 2c, and the personal terminal 2b and the personal terminal 2c are connected to the room. The user management DB 6002 illustrated in FIG. 7 is used in the login process in step S12.

The presenter and the attendees connected to the room are registered in the personal memo DB 6001 illustrated in FIG. 6 and conduct a meeting. First, in step S14, the personal terminal 2a receives an operation of selecting a target to be streamed to the shared screen ss. This operation is an example of an operation of sharing start (start of screen sharing) from the presenter. The personal terminal 2a uploads data of the content selected to be streamed to the shared screen ss of the content management server 6 by streaming.

In step S16, the content management server 6 transmits the content data uploaded by streaming to the shared screen ss, to the personal terminal 2b and the personal terminal 2c of the attendees who are participating in the same room in which the presenter is participating. Thereby, the personal terminal 2b of the attendee B and the personal terminal 2c of the attendee C participating in the room receive the image of the shared screen ss.

The processes of steps S16 to S28 are repeated until the screen sharing of the shared screen ss ends. During a time period when the screen sharing of the shared screen ss is performed, the attendee B and the attendee C presses a capture button at a timing when a desired shared screen ss to be captured as a capture image is displayed, to instruct a capture shooting request of the shared screen ss.

In step S18, the personal terminal 2b of the attendee B and the personal terminal 2c of the attendee C receives the operation of pressing the capture button and transmits the capture shooting request of the shared screen ss to the content management server 6.

In step S20, in response to receiving the capture shooting request, the content management server 6 shoots a capture image of the shared screen SS of the current time and the stores the capture image. Further, the content management server 6 stores information in the table of FIG. 8A. Furthermore, the personal terminal 2b of the attendee B and the personal terminal 2c of the attendee C display the capture image of the shared screen ss captured by the content management server 6. The attendee B who operates the personal terminal 2b and the attendee C who operates the personal terminal 2c are allowed to enter text, a graphic object, vector data, etc. as memo information in the capture image of the displayed shared screen ss. Although in the present embodiment, the content management server 6 captures (shoots) a capture image, no limitation is intended thereby. In another example, each personal terminal performs the screen capturing, and the content management server 6 receives the capture image from each personal terminal, whereby the content management server 6 acquires the capture image.

Steps S22 and S24 are processes performed when memo information by text is entered. When the memo information by text is entered, the content management server 6 stores information in the table of FIG. 8B so that the capture image and the text are associated with each other.

Steps S26 and S28 are processes performed when memo information is entered by a graphic object. When the memo information by a graphic object is entered, the content management server 6 stores information in the table of FIG. 8A so that the capture image and the graphic object are associated with each other.

In step S30, the personal terminal 2a receives an operation of a sharing end (end of screen sharing) from the presenter. The personal terminal 2a transmits a notification indicating the sharing end of the shared screen ss to the content management server 6, and ends the screen sharing of the shared screen ss. Further, in step S32, the content management server 6 ends the transmission of the image of the shared screen ss to the personal terminal 2b of the attendee B and the personal terminal 2c of the attendee C, who are participating in the same room in which the presenter is participating.

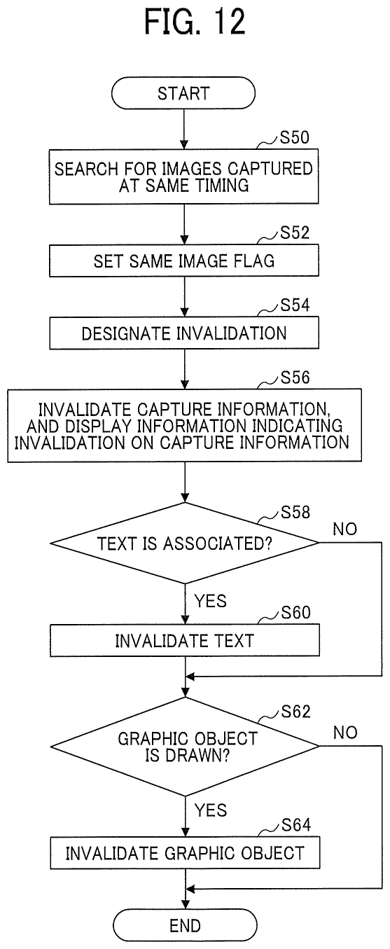

Further, in step S36, the presenter performs an invalidation process of invalidating the capture image captured by the attendee B and the attendee C to control the invalidated capture image not to be displayed by processes as illustrated in FIG. 12, for example. FIG. 12 is a flowchart illustrating an example of an invalidation operation, according to the present embodiment.

In step S50, the content management server 6 searches the personal memo DB 6001 of FIG. 6 and the content management DB 6003 of FIG. 8A to FIG. 8C for a capture image captured at the same timing (the timing when the shared screen ss having the same content was displayed) during the meeting. Regarding the timing when the shared screen ss having the same content was displayed, the timing of page change may be identified from a change amount of the shared screen ss to determine the timing when the shared screen ss having the same content was displayed. When there is any capture image captured at the same timing, the same image ID is set in the table of FIG. 8A and the same image ID is set in the table of FIG. 8C.

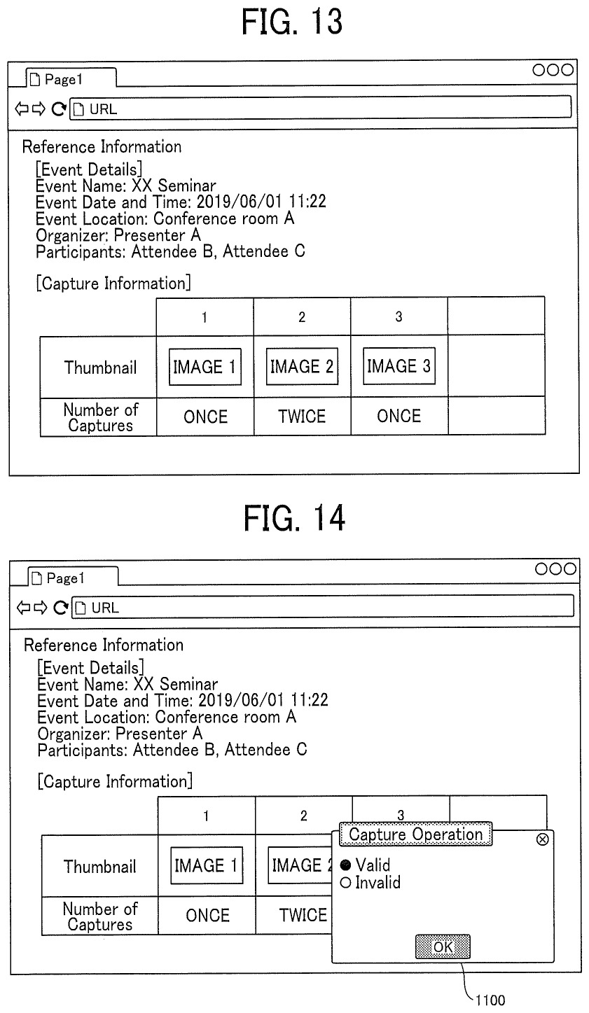

In step S54, the content management server 6 uses the personal memo DB 6001 of FIG. 6 and the content management DB 6003 of FIG. 8A to FIG. 8C, to control the personal terminal 2a of the presenter to display a capture image display screen as illustrated in FIG. 13.

FIG. 13 is an illustration of an example of the capture image display screen. The capture image display screen of FIG. 13 displays a list of capture images captured by the attendees at a meeting indicated by reference information is displayed in a thumbnail format. Further, the number of captures for each capture image is displayed.

When the list of capture images displayed in FIG. 13 includes any capture image that the presenter thinks that the presenter should not have allowed the attendee B and the attendee C to capture, the presenter selects such capture image. In response to the presenter's selection, a capture operation screen 1100 as illustrated in FIG. 14, for example, is displayed, on which screen the presenter designates valid or invalid for each capture image.

FIG. 14 is an illustration of an example of the capture image display screen on which the capture operation screen is displayed. The presenter switches from “Valid” to “Invalid” on the capture operation screen 1100 of FIG. 14, to invalidate the selected capture image.

When the capture image is invalidated, in step S56, the content management server 6 updates the content management DB 6003 of FIG. 8A to FIG. 8C so that the invalidated capture image is not displayed on the personal terminal 2b operated by the attendee B and the personal terminal 2c operated by the attendee C.

Examples of the process of updating the content management DB 6003 of FIG. 8A to FIG. 8C so that the invalidated capture image is not displayed on the personal terminal 2b operated by the attendee B and the personal terminal 2c operated by the attendee C include an editing process of rewriting a flag specifying whether the capture operation is valid or invalid. When the flag specifying whether the capture operation is valid or invalid specifies that the capture operation is invalid, the content management server 6 displays, instead of the capture image 1010c and the capture image 1020c, an invalidation screen 1030 indicating that the corresponding image has been invalidated, as illustrated in FIG. 10, for example. The invalidation screen 1030 is common to the capture image 1010c and the capture image 1020c, for example. Note that the invalidation screen 1030 is an example.

Further, the process of controlling the invalidated capture image not to be displayed on the personal terminal 2b operated by the attendee B and the personal terminal 2c operated by the attendee C may be implemented, for example, instead of by setting the flag, by deleting the capture image itself stored in the content management DB 6003, or by editing the capture image to an image displaying “Invalidated”. When the capture image itself stored in the content management DB 6003 is deleted, the content management server 6 determines, in response to a request for displaying the personal memo from the personal terminal 2 of the attendee, whether the capture image to be displayed is deleted. Based on determination that the capture image to be displayed has been deleted, a screen “Invalidated” is displayed as illustrated in FIG. 10, for example. When the capture image itself is edited to the image displaying “invalidated”, the image obtained by the editing is displayed as it is, and the determination process is not required.

The indication “Invalidated” displayed on the personal terminal 2 of the attendee in FIG. 10 is merely an example. In another example, an indication such as “Capture image cannot be displayed”, “Data related to this page has been deleted”, “Edited by presenter” can be displayed.

In step S58, the content management server 6 refers to the content management DB 6003 of FIG. 8A to FIG. 8C, to determine whether any text is associated with the invalidated capture image as memo information.

Based on the determination that text is associated with the invalidated capture image as the memo information, the content management server 6 invalidates the text associated with the invalidated capture image in step S60. When the text is invalidated, the content management server 6 updates the content management DB 6003 of FIG. 8A to FIG. 8C so that the invalidated text is not displayed on the personal terminal 2b operated by the attendee B and the personal terminal 2c operated by the attendee C. Then, the content management server 6 displays that the text that was displayed in association with the capture image 1010c or the capture image 1020c is invalidated, as illustrated in FIG. 10, for example.

The processing of controlling the invalidated text not to be displayed on the personal terminal 2b operated by the attendees B and the personal terminal 2c operated by the attendee C is implemented by controlling the text associated with the capture image not to be displayed, when the flag specifying the capture operation is valid or invalid specifies that the capture operation is invalid. Further, the process of controlling the invalidated text not to be displayed on the personal terminal 2b operated by the attendee B and the personal terminal 2c operated by the attendee C may be implemented, for example, instead of by setting the flag, by deleting the text itself stored in the content management DB 6003, or by editing the text itself to “Invalidated”. Thus, the content management server 6 determines whether the flag specifying whether the capture operation is valid or invalid is set to “invalid” or whether the text itself has been deleted from the content management DB 6003, and displays “Invalidated” in a memo field 1050 corresponding to the capture image of the personal memo. When the text itself is edited to “Invalidated”, the edited text is displayed as it is, and the determination process is not required.

The indication “Invalidated” displayed on the personal terminal 2 of the attendee in FIG. 10 is merely an example. In another example, an indication such as “Capture screen cannot be displayed”, “Data related to this page has been deleted”, “Edited by presenter” can be displayed.

In step S62, the content management server 6 refers to the content management DB 6003 of FIGS. 8A to 8C, to determine whether any graphic object or vector data is associated with the invalidated capture image as memo information. Based on the determination that any graphic object or vector data is associated with the invalidated capture image as the memo information, the content management server 6 invalidates the graphic object or the vector data associated with the invalidated capture image in step S64

When the graphic object or the vector data is invalidated, the content management server 6 updates the content management DB 6003 of FIG. 8A to FIG. 8C so that the invalidated graphic object or the invalidated vector data is not displayed on the personal terminal 2b operated by the attendee B and the personal terminal 2c operated by the attendee C. Then, the content management server 6 displays that the graphic object or vector data that was displayed in association with the capture image 1010c or the capture image 1020c is invalidated, as illustrated in FIG. 10, for example.

According to the present embodiment, the information sharing system that allows the attendee B and attendee C capture a capture image of the shared screen ss and refer to the capture image later by performing an operation such as pressing the capture button invalidates the capture image captured by the attendee B and the attendee C later in response to an instruction operation by the presenter so that the attendee B and the attendee C cannot refer to the invalidated capture image.

Thus, according to the present embodiment, when the presenter later notices that the presenter should not have allowed the attendee B and the attendee C to capture the image 1000c of the shared screen ss, because the image 1000c of the shared screen ss is not suitable for sharing, such as the image 1000c of the shared screen ss containing confidential information, such capture image is invalidated not to be displayed.

### Second Embodiment

In the first embodiment, the effect of the selection by the presenter of the image 1000c of the shared screen ss and the invalidation of the capture image 1010c and the capture image 1020c obtained by capturing the image 1000c of the shared screen ss is applied to each of the attendees of the meeting. In the second embodiment, the applicable range is changed according to attributes of the attendees.

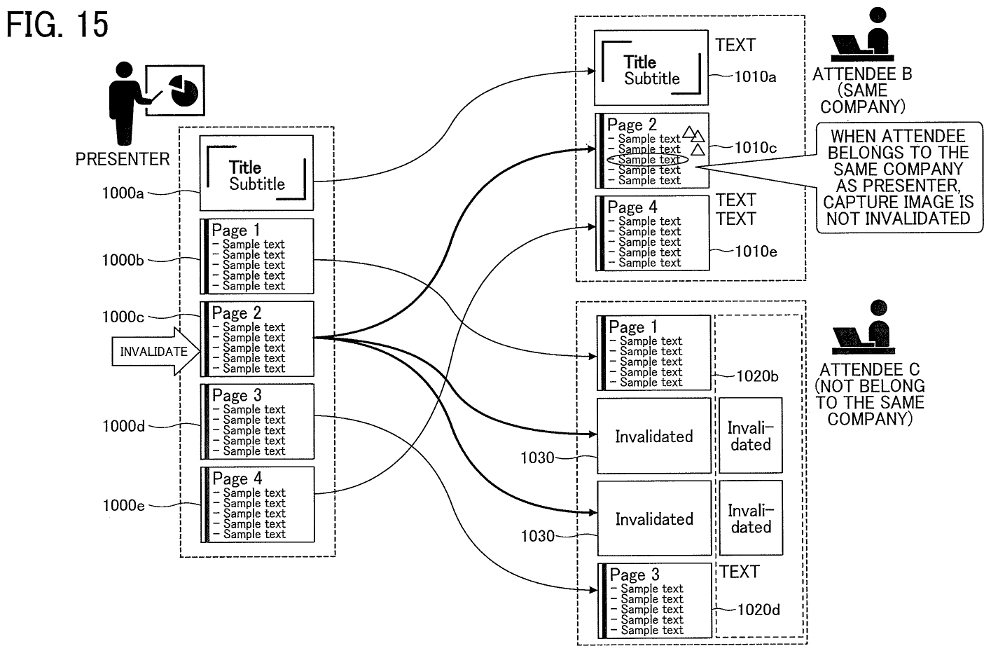

FIG. 15 is an illustration for describing an example of an image of the shared screen ss and a capture image obtained by capturing the shared screen ss. FIG. 15 differs from FIG. 9 and FIG. 10 in that the attendee B is a participant who belongs to the same company of the presenter, not a participant who does not belong to the same company as the presenter.

In the example of FIG. 15, a mechanism is provided that does not invalidate the capture image 1010c captured by the attendee B, who is a participant belonging to the same company as the presenter, and invalidates the capture image 1020c captured by the attendee C, who is a participant not belonging to the same company as the presenter, so that the invalidated capture image is not displayed.

When the presenter later notices that the presenter should not have allowed the attendee C, who does not belong to the same company as the presenter, to capture the image 1000c of the shared screen ss, the presenter selects the image 1000c of the shared screen ss, to invalidate the capture image 1020c obtained by capturing the image 1000c of the shared screen ss. Further, as illustrated in FIG. 15, the memo information such as text, graphic objects, and vector data associated with the invalidated capture image 1020c is also invalidated.

As illustrated in FIG. 15, the effect of the selection by the presenter of the image 1000c of the shared screen ss and the invalidation of the capture image 1020c obtained by capturing the image 1000c of the shared screen ss is not applied to all the attendees of the meeting, and the applicable range is changed according to the attributes of the attendees such as whether or not the attendee belongs to the same company as the presenter.

The embodiment is not limited to the example illustrated in FIG. 15, and for example, the memo information such as text, graphic objects, and vector data associated with the invalidated capture image 1020c may be left without being invalidated.

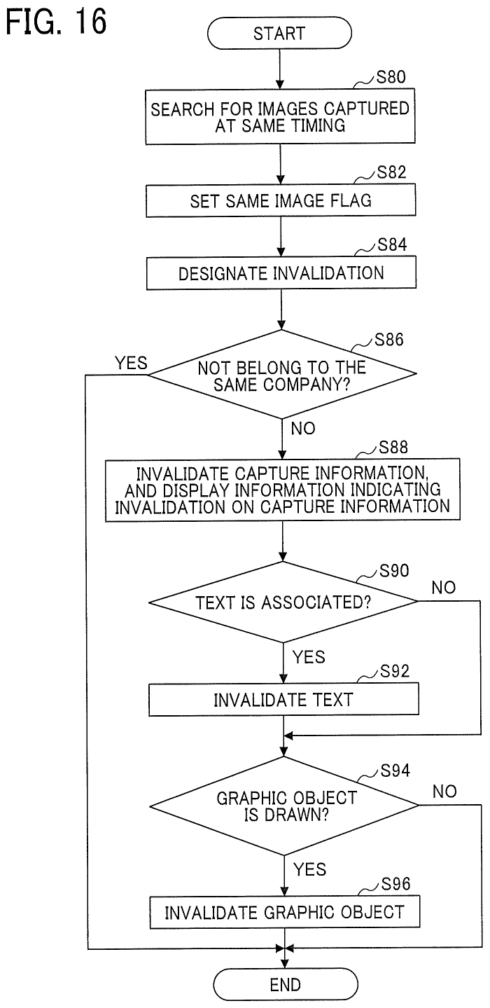

In the second embodiment, the presenter performs an invalidation process of invalidating the capture image captured by the attendee C to control the invalidated capture image not to be displayed by processes as illustrated in FIG. 16, for example. FIG. 16 is a flowchart illustrating an example of an invalidation operation, according to the present embodiment.

In step S80, the content management server 6 searches the personal memo DB 6001 of FIG. 6 and the content management DB 6003 of FIG. 8A to FIG. 8C for a capture image captured at the same timing (the timing when the shared screen ss having the same content was displayed) during the meeting. When there is any capture image captured at the same timing, in step S82, the same image ID is set in the table of FIG. 8A and the same image ID is set in the table of FIG. 8C.

In step S84, the content management server 6 uses the personal memo DB 6001 of FIG. 6 and the content management DB 6003 of FIG. 8A to FIG. 8C, to control the personal terminal 2a of the presenter to display the capture image display screen as illustrated in FIG. 13.

The capture image display screen of FIG. 13 displays a list of capture images captured by the attendees at a meeting indicated by reference information is displayed in a thumbnail format. Further, the number of captures for each capture image is displayed.

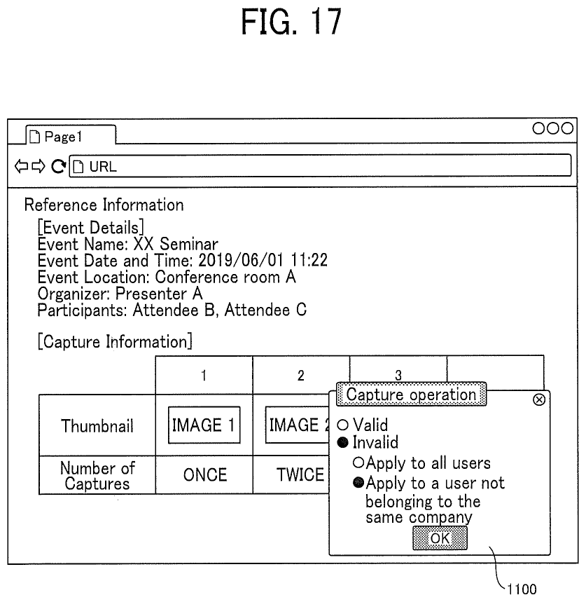

When the list of capture images displayed in FIG. 13 includes any capture image that the presenter thinks that the presenter should not have allowed the attendee C to capture, the presenter selects such capture image. In response to the presenter's selection, the capture operation screen 1100 as illustrated in FIG. 17, for example, is displayed. The capture operation screen 1100 illustrated FIG. 17 allows the presenter to specify, for each capture image, an applicable range such as “Apply to all users” and “Apply to a user not belonging to the same company”, and valid or invalid of the capture operation.

FIG. 17 is an illustration of an example of the capture image display screen on which the capture operation screen 1100 is displayed. The presenter switches from “Valid” to “Invalid” and selects “Apply to a user not belonging to the same company” on the capture operation screen 1100 of FIG. 17. In step S86, the content management server 6 determines whether “Apply to a user not belonging to the same company” is selected. Based on the determination that “Apply to a user not belonging to the same company”, the content management server 6 performs the processes of steps S88 to S96, to invalidate the capture image captured by the personal terminal 2c operated by the attendee C. The processes of S88 to S96 are performed in substantially the similar manner as described above referring to S56 to S64 of FIG. 12, and redundant description thereof is omitted.

According to the present embodiment, the information sharing system that allows the attendee B and attendee C capture a capture image of the shared screen ss and refer to the capture image later by performing an operation such as pressing the capture button invalidates the capture image captured by the attendee C, who does not belong to the same company as the presenter, later in response to an instruction operation by the presenter so that the attendee C cannot refer to the invalidated capture image later.

Thus, according to the present embodiment, when the presenter later notices that the presenter should not have allowed the attendee C, who does not belong to the same company as the presenter, to capture the image 1000c of the shared screen ss while the attendee B, who belongs to the same, company as the presenter, is allowed to capture the image 1000c, because the image 1000c of the shared screen ss is not suitable for sharing to the attendee C, who does not belong to the same company as the presenter, such as the image 1000c of the shared screen ss containing confidential information, the capture image captured in response to the instruction operation by the attendee C is invalidated so as not to be displayed.

### Modified Examples

Although in the first embodiment and the second embodiment, the description given is of an example in which the capture operation is switched from valid to invalid, the embodiments are not limited thereto. In another example, the capture operation is switched from invalid to valid. For example, the information sharing system according to the modified example invalidates a capture image after the meeting and validates the capture image after a predetermined number of days (for example, 30 days) have passed. In another example, the information sharing system according to the modified example invalidates a capture image after the meeting, and the validate the capture image when the attendee pay the charge.

With such a feature, the information sharing system according to the modified example improves the motivation of the presenter by being paid.

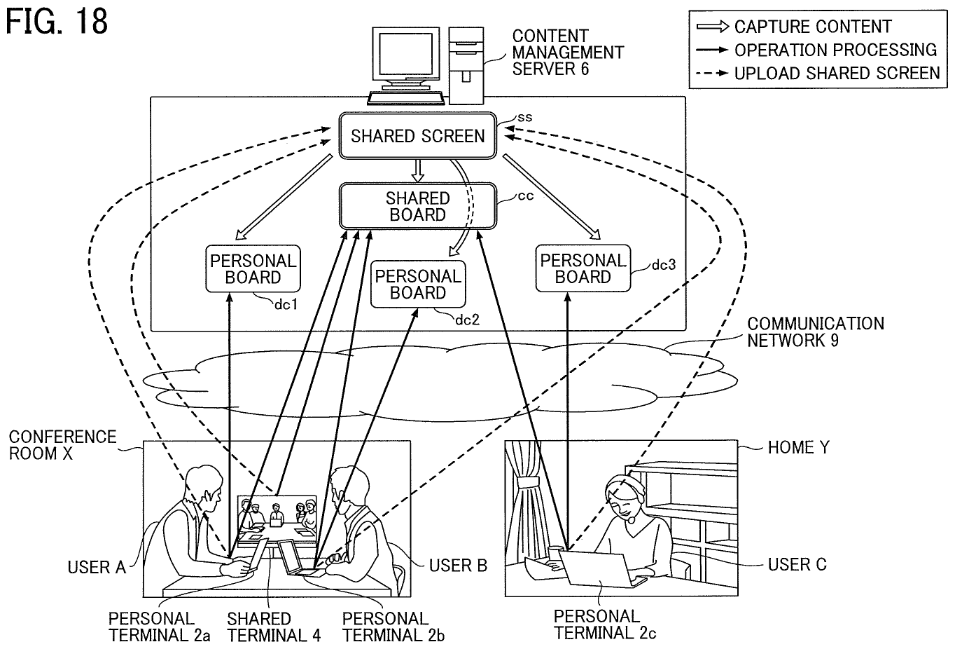

Further, the information sharing system illustrated in FIG. 1 is one example, and the embodiments are not limited thereto. In another example, the information sharing system may have a configuration as illustrated in FIG. 18. FIG. 18 is a schematic diagram illustrating an overview of the information sharing system used in a meeting being conducted. FIG. 18 illustrates a case in which the user A and the user B who are in the conference room X of a company and the user C who is at a home Y are conducting a remote meeting by using the information sharing system. The user A uses the personal terminal 2a in the conference room X, and the user B uses the personal terminal 2b in the conference room X. On the other hand, the user C uses the personal terminal 2c at the home Y.

Further, a shared terminal 4 that can be shared by multiple users is provided in the conference room X. The shared terminal 4 is a computer that multiple users can use together and whose screen is viewed by the multiple users. Examples of the shared terminal 4 includes, but not limited to a projector (PJ), an interactive whiteboard (IWB), a digital signage, a display to which a stick PC is connected. The IWB is a whiteboard having an electronic whiteboard function having mutual communication capability. The shared terminal 4 is an example of a communication terminal (or an information processing terminal). The shared terminal 4 is communicable with the content management server 6 through the communication network 9 such as the Internet.

The content management server 6 is a computer functioning as a web server (or HTTP server) that stores and manages data of contents to be transmitted to the personal terminal 2 and the shared terminal 4. The storage unit 6000 includes, in addition to the configuration of FIG. 1, a storage location (or storage area) for implementing a shared board cc, which is accessible from any personal terminals 2.

The “shared board cc” is a virtual space generated in the storage location (or the storage area) in the storage unit 6000 of the content management server 6. For example, the shared board cc is accessible by using a web application having a function of allowing a user to view and edit contents with the Canvas element and JavaScript (registered trademark). The “web application” refers to software used on a web browser. The web application is implemented by a program written in a script language such as JavaScript (registered trademark) that operates on the web browser and a program on a web server side, which operate in cooperation with each other. Further, the web application refers to a mechanism that implements such software. The shared board cc has a finite or an infinite area within the range of the storage area in the storage unit 6000. For example, the shared board cc may be finite or infinite both in the vertical and horizontal directions. In another example, the shared board cc may be finite or infinite in either the vertical direction or the horizontal direction.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above. For example, the information sharing system according to the embodiments can be used in the following situations.

In general seminars, customers correspond to the attendees of the embodiments, and a sales person corresponds to the presenter of the embodiments. When the information sharing system is used in schools, students correspond to the attendees of the embodiments, and a teacher correspond to the presenter of the embodiments. In general meetings, employees correspond to the attendees of the embodiments, and management corresponds to the presenter of the embodiments. In addition, although in the embodiments, the description given above is of the example in which the personal terminal 2 accesses the web page of the content management server 6 via the web browser, the embodiments are not limited thereto. The personal terminal 2 may access the web page of the content management server 6 from a dedicated application installed on the personal terminal 2 other than the general-purpose browser. In still another example, the screen may be provided to the personal terminal 2 in a file format other than the web page.

According to one or more embodiments of the disclosure, an information processing system is provided configured to control not to display a capture image acquired from an image on a shared screen.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), and field programmable gate array (FPGA), and conventional circuit components arranged to perform the recited functions.

The storage control unit 71 is an example of storage control means. The selection receiving unit 70 is an example of selection receiving means. The web page generation unit 66 is an example of generation means. The data exchange unit 61 is an example of transmission means. The display control unit 24 is an example of display control means. The capture image is an example of a captured image. The capture shooting request is an example of a capture request.

What is claimed is:

1. An information processing system comprising:
a plurality of communication terminals; and
an information processing apparatus comprising first circuitry to
acquire one or more images of a shared screen to be shared by the plurality of communication terminals, each image being captured in response to occurrence of a trigger for capturing an image of the shared screen,
store the acquired one or more images as one or more captured image, in a memory,
receive a selection of a particular captured image that is not to be displayed on at least one communication terminal of the plurality of communication terminals from the one or more captured images,
generate data of a screen including the one or more captured images to be displayed on the at least one communication terminal, the screen not displaying at least a part of the one or more captured images based on the received selection, and
transmit the generated data to the at least one communication terminal,
each of the plurality of communication terminals including second circuitry configured to display the screen based on the data received from the information processing apparatus.

2. The information processing system of claim 1, wherein
when additional information is stored in association with the particular captured image that is not to be displayed on the at least one communication terminal in the memory, the first circuitry of the information processing apparatus is further configured to generate, based on the received selection, the data of the screen not including the additional information stored in association with the particular captured image that is not to be displayed on the at least one communication terminal.

3. The information processing system of claim 1, wherein
the first circuitry of the information processing apparatus is further configured to switch between a process of generating the data of the screen not displaying the at least the part of the one or more captured image based on the received selection and a process of generating the data of the screen including the one or more captured images regardless of the received selection, according to attributes of users operating the plurality of communication terminals.

4. The information processing system of claim 3, wherein
the first circuitry of the information processing apparatus is further configured to store, in the memory, the one or more captured images captured in response to a capture request from the plurality of communication terminals as the occurrence of the trigger in association with a user operating a particular communication terminal as a source of the capture request.

5. The information processing system of claim 1, wherein
the first circuitry of the information processing apparatus is further configured to:
receive the selection of the particular captured image that is not to be displayed on the plurality of communication terminals from the one or more captured images; and
generate the data of the screen not including the particular captured image for which the selection is received from the one or more captured images.

6. The information processing system of claim 1, wherein the screen is a web page.

7. An information processing apparatus communicable with a plurality of communication terminals, the information processing apparatus comprising circuitry to:
acquire one or more images of a shared screen to be shared by the plurality of communication terminals, each image being captured in response to occurrence of a trigger for capturing an image of the shared screen;
store the acquired one or more images as one or more captured image, in a memory;
receive a selection of a particular captured image that is not to be displayed on at least one communication terminal of the plurality of communication terminals from the one or more captured images;
generate data of a screen including the one or more captured images to be displayed on the at least one communication terminal, the screen not displaying at least a part of the one or more captured images based on the received selection; and
transmit the generated data to the at least one communication terminal.

8. An information processing method performed by an information processing apparatus communicable with a plurality of communication terminals, the information processing method comprising:
acquiring one or more images of a shared screen to be shared by the plurality of communication terminals, each image being captured in response to occurrence of a trigger for capturing an image of the shared screen;
storing the acquired one or more images as one or more captured image, in a memory;
receiving a selection of a particular captured image that is not to be displayed on at least one communication terminal of the plurality of communication terminals from the one or more captured images;
generating data of a screen including the one or more captured images to be displayed on the at least one communication terminal, the screen not displaying at least a part of the one or more captured images based on the received selection; and
transmitting the generated data to the at least one communication terminal.

9. A non-transitory computer-readable medium storing a program that causes an information processing apparatus to execute the method of claim 8.
